(19) United States
(12) Patent Application Publication
(10) Pub. No.: US 2010/0269684 A1
(43) Pub. Date: Oct. 28, 2010

(54) Vacuum Brake Booster for a Motor Vehicle Brake System

(76) Inventors: Peter Schlüter, Kammerforst (DE); Frank Schlüter, Boppard (DE); Alexander Schlüter, Kammerforst (DE); Stefan Schlüter, Kammerforst (DE); Irina Gerdt, Kammerforst (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/682,314

(22) PCT Filed: Oct. 1, 2008
(86) PCT No.: PCT/EP2008/008318

§ 371 Date: Jun. 21, 2010

(30) Foreign Application Priority Data
Oct. 12, 2007 (DE) 10 2007 049 122.2

(51) Int. Cl. F15B 9/10

(52) U.S. Cl. 91/374

(57) ABSTRACT

The present invention relates to a vacuum brake booster for a motor vehicle brake system, having a force input element that is connectable or connected to a brake pedal, a chamber arrangement comprising a vacuum chamber and a working chamber that are separated from one another by a movable wall, a control valve with a valve element for selectively connecting and separating vacuum chamber and working chamber, and a force output element for transmitting an output force to a master cylinder, wherein the force input element is workingly connectable or connected to a transmission piston arrangement disposed in the control valve, wherein the control valve is settable in accordance with a displacement of the transmission piston arrangement along a longitudinal axis by means of the force input element. In this case, it is provided that the transmission piston arrangement is provided with at least one pressure compensation channel, by means of which a pressure compensation is effected at the valve element.

### CROSS-REFERENCE TO RELATED APPLICATIONS

This application is a national stage of International Application No. PCT/EP2008/008318 filed Oct. 1, 2008, the disclosure of which is incorporated herein by reference, and which claimed priority to German Patent Application No. 10 2007 049 122.2 filed Oct. 12, 2007, the disclosure of which is incorporated herein by reference.

### BRIEF SUMMARY OF THE INVENTION

The present invention relates to a vacuum brake booster for a motor vehicle brake system, having a force input element that is connectable or connected to a brake pedal, a chamber arrangement comprising a vacuum chamber and a working chamber that are separated from one another by a movable wall, a control valve with a valve element for selectively connecting and separating vacuum chamber and working chamber, and a force output element for transmitting an output force to a master cylinder, wherein the force input element is workingly connectable or connected to a transmission piston arrangement disposed in the control valve, wherein the control valve is settable in accordance with a displacement of the transmission piston arrangement along a longitudinal axis by means of the force input element.

Such vacuum brake boosters are prior art. For example, the document DE 40 21 304 A1 discloses a vacuum brake booster, in which by means of the force input element the transmission piston arrangement is displaceable against the resistance of a resetting spring. On the transmission piston arrangement a first valve seat is provided, which interacts with a valve element. As a result of the displacement of the transmission piston arrangement this valve seat is lifted off the valve element, thereby leading to a connection of the working chamber to the atmosphere and hence to a pressure build-up at the movable wall. As a result of the pressure difference arising at the movable wall, the control valve housing is correspondingly re-displaced until the open valve seat closes again. The vacuum brake booster is then situated once more in a state of equilibrium, wherein an output force corresponding to the displacement of the force input element is transmitted by the force output element to a master cylinder arrangement. If the force input element is released, it is moved together with the transmission piston arrangement back in the direction of its initial position owing to the action of the resetting spring. In this case, a second valve seat is opened, with the result that a pressure compensation may be effected between the vacuum chamber and the working chamber. The control valve housing consequently moves back into its initial position. For this purpose, the resetting spring has to be designed in such a way that it overcomes all of the pressure-related counterforces that arise.

A substantial drawback of this vacuum brake booster is that during operation at the valve element a differential pressure arises, which is caused by the fact that at a side of the valve element facing the force input element atmospheric pressure is permanently applied, whereas upon a brake pedal actuation the pressure prevailing in the working chamber is applied to the opposite side of the valve element. In many operating situations this pressure is lower than atmospheric pressure, thereby resulting in the pressure difference at the valve element. During the return of the control valve housing to its initial position, this pressure difference counteracts a movement of the valve element. It has to be overcome in order to open the second valve seat. As the resetting movement is effected solely by the resetting spring, the resetting spring has to have a sufficiently high spring constant. However, this in turn means that correspondingly high forces are also needed for the actuation of the vacuum brake booster and for the compression of the resetting spring associated therewith. In other words, the differential pressure arising at the valve element causes an increase of the actuating forces and therefore influences the response characteristic of this vacuum brake booster. This conflicts with the requirement for comfortable actuation of the brake system.

As further prior art, reference is made to the documents EP 0 830 276 B1, and corresponding U.S. Pat. No. 5,799,559, both of which are incorporated by reference herein, and EP 0 655 039 B2, and corresponding U.S. Pat. No. 5,546,846, both of which are incorporated by reference herein. These documents also disclose in each case vacuum brake boosters of prior art, in which a force input element is connected to a transmission piston arrangement, wherein at the valve element during operation a differential pressure may build up and leads to the increase of the actuating forces that are to be summoned up.

To combat this problem of the high actuating forces, the document DE 42 27 879 A1, and corresponding U.S. Pat. No. 5,546,846, both of which are incorporated by reference herein, proposes that in a bellows-like valve element a plurality of axial openings be provided, by means of which a pressure compensation may occur. This means however that the valve element manufactured from elastomer material has to be pierced a plurality of times and, in order to retain its stability, has to be strengthened elsewhere. The valve element as a whole is however nevertheless more susceptible to failure.

### BRIEF SUMMARY OF THE INVENTION

A desired feature of the invention is to provide a vacuum brake booster of the initially described type, in which for a low constructional outlay and without increasing the susceptibility to failure the actuating forces may be reduced compared to the conventional solutions of prior art.

This feature is achieved by a vacuum brake booster of the initially described type, in which the transmission piston arrangement is provided with at least one pressure compensation channel, by means of which during operation a pressure compensation is effected at the valve element.

The effect achievable by providing at least one pressure compensation channel is that a differential pressure that builds up during operation at the valve element may be kept to a minimum or such a differential pressure build-up may even be entirely prevented, with the result that the valve element during operation is displaceable in a substantially “pressure-neutral” manner inside the control valve. It is thereby possible to avoid having to design the resetting spring strong enough in terms of its spring force to be able to cope additionally with the differential pressure during a resetting movement. Because of the weaker design according to the invention of the resetting spring, a driver upon an actuation of the brake pedal experiences lower counterforces, thereby on the whole enabling a more comfortable actuation. By virtue of preventing the development of such a differential pressure because of the provision of at least one pressure compensation channel in the transmission piston arrangement, i.e. in a dimensionally stable component, it is moreover possible to prevent the vacuum brake booster from being more susceptible to failure. The valve element manufactured from an elastomer may be formed free of holes and is therefore, on the one hand, easier to produce and, on the other hand, less susceptible to faults.

In a variant of the invention it may be provided that the control valve comprises a control valve housing, wherein the transmission piston arrangement is guided in the control valve housing so as to be displaceable relative thereto and relative to the valve element. The valve element in this case is formed in a bellows-like manner from an elastomer and ensures a sealing abutment with corresponding valve seats. According to an embodiment of the invention it is provided that the transmission piston arrangement has an axial guide portion, which is guided sealingly in the valve element. In this connection, according to the invention it may be provided that a first pressure compensation channel is provided in the guide portion that extends substantially in axial direction from a pneumatic region connected to the working chamber into a first pneumatic region delimited by the valve element. In addition or alternatively thereto, a development of the invention provides that a second pressure compensation channel is provided in the guide portion that extends substantially in radial direction from a pneumatic region connected to the atmosphere into a second pneumatic region delimited by the valve element. The valve element may therefore be kept substantially pressure-neutral, with the result that its displacement, in particular by means of a resetting spring, is possible with a low expenditure of force.

To guarantee a sealing guidance of the guide portion relative to the valve element, according to the invention it may be provided that the valve element has first sealing means, by which the guide portion is guided sealingly in the valve element. The valve element in turn may have second sealing means, by which it is sealingly guided in the control valve housing.

As already stated above, the valve element may be of a bellows-like construction, wherein it then comprises a displaceable part and a part that is fixed in the control valve housing. In this connection, according to the invention it may be provided that the valve element is held in the control valve housing by means of a retaining element. In this case, the guide portion may be guided sealingly relative to the retaining element. With regard to the displaceable part, according to the invention it may be provided that it is preloaded into an initial position by means of a resetting spring.

Instead of an integral valve element of a bellows-like construction, the valve element may be of a multi-part construction. A development of the invention therefore provides that the valve element comprises a dimensionally stable carrier element with an elastomer coating, wherein the valve element interacts with the retaining element. Unlike in the case of the valve element of a bellows-like construction, the sealing relative to the control valve housing is achieved for example in that additional sealing means are attached to the retaining element.

It has already been indicated above that the vacuum brake booster according to the invention, exactly like conventional vacuum brake boosters, comprises two sealing seats, by means of which the working chamber may be connected selectively to the vacuum chamber or to the ambient atmosphere. In this connection, an embodiment of the invention provides that a first sealing seat is provided on the control valve housing for interaction with the valve element and that a second sealing seat is provided on a component of the transmission piston arrangement or valve element for interaction with the respective other component of the transmission piston arrangement or valve element. According to the invention the geometry of the valve seats may be selected differently. For example, the valve seats may in each case take the form of a circumferential annular projection on the control valve housing or on the transmission piston arrangement and interact sealingly with a corresponding planar sealing face on the valve element. It may however alternatively be provided that planar sealing faces are provided on the control valve housing or/and on the transmission piston arrangement, wherein corresponding sealing projections or edges are formed on the valve element.

With regard to the design of the guide portion relative to the transmission piston arrangement it may be provided that these are formed integrally with one another. As an alternative to this, the transmission piston arrangement may however be of a multi-part construction, for example such that the guide portion is formed as a separate component separately from the transmission piston arrangement but connected sealingly thereto. Manufacture of the transmission piston arrangement as a whole may therefore be simplified because for example the relatively complex geometry of the mechanically less highly loaded guide portion may be manufactured by a suitable manufacturing method preferred for this purpose, such as for example by injection moulding. The piston element, which because of the pressure loading during actuation is mechanically loaded to a greater extent and which during operation comes into interaction with a rubber-elastic reaction element, may then be designed for example as a correspondingly solid component. In this connection, it may further be provided that the guide portion and the transmission piston arrangement are manufactured from different materials.

Given a multi-part construction of the transmission piston arrangement, it is necessary for the individual parts to be connected reliably and sealingly to one another. According to a variant of the invention the transmission piston arrangement has a fastening formation for sealingly receiving the guide portion. Thus, the guide portion of a bush-like construction may for example be inserted into an annular recess in the transmission piston arrangement that is tuned to the guide portion. Optionally, for this purpose an edge-formed fastening may additionally be provided in order to fix the guide portion securely to the transmission piston arrangement.

In order to guarantee an adequate sealing in the case of a multi-part transmission piston arrangement, it may be provided that at least one sealing element is provided between the transmission piston arrangement and the guide portion in the region of the fastening formation.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is an overview representation of a first embodiment of a vacuum brake booster according to the invention in the axis-containing longitudinal section;

FIG. 2 is a detail view of the control valve according to the first embodiment of the invention according to FIG. 1;

FIG. 3 is a view corresponding to FIG. 2 of a second embodiment of the invention;

FIG. 4 is a view corresponding to FIG. 2 of a third embodiment of the invention;

FIG. 5 is a view corresponding to FIG. 2 of a fourth embodiment of the invention;

FIG. 6 is a view corresponding to FIG. 2 of a fifth embodiment of the invention and

FIG. 7 is a view corresponding to FIG. 2 of a sixth embodiment of the invention.

### DETAILED DESCRIPTION OF THE INVENTION

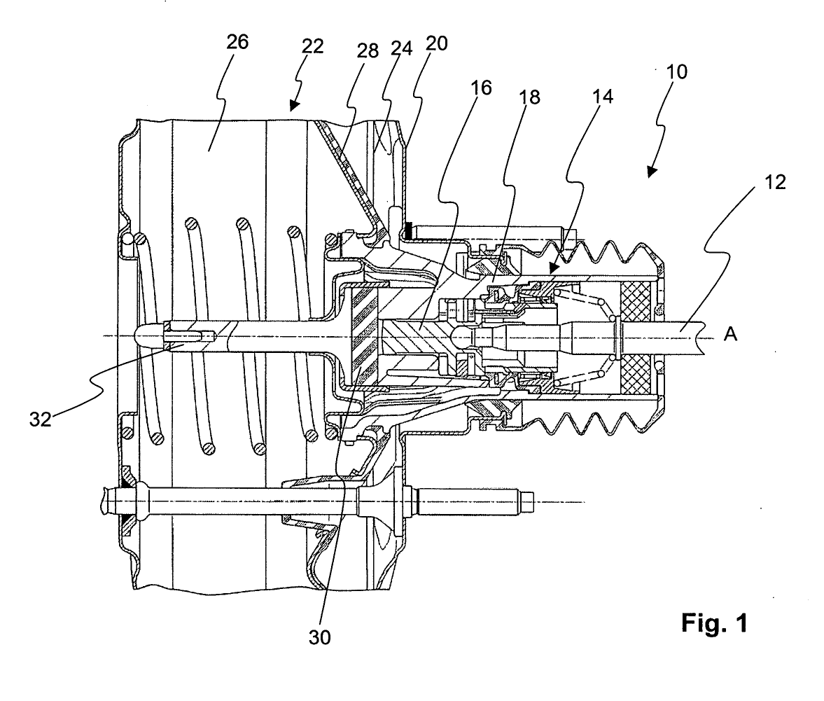

In FIG. 1 a vacuum brake booster according to the invention is shown in a sectional view containing a longitudinal axis A and is generally denoted by 10. It comprises a force input element 12, which is connected for actuation to a non-illustrated brake pedal. The force input element 12 projects into a control valve 14 and is connected for joint movement to a transmission piston arrangement 16, which is guided in the control valve 14 so as to be displaceable along the longitudinal axis A.

The control valve 14 has a control valve housing 18, which is guided in a brake booster housing 20 so as to be displaceable along the longitudinal axis A. In the brake booster housing 20 a chamber arrangement 22 comprising a working chamber 24 and a vacuum chamber 26 is provided, wherein the working chamber 24 is separated from the vacuum chamber 26 by a movable wall 28. The movable wall 28 is connected for joint movement in a fixed manner to the control valve housing 18. Such a movement of the control valve housing 18 as well as a movement of the transmission piston arrangement 16 that is induced by a movement of the force input element 12 are transmitted via a rubber-elastic reaction element 30 to a force output element 32. The force output element 32 is workingly connectable to a non-illustrated master cylinder arrangement.

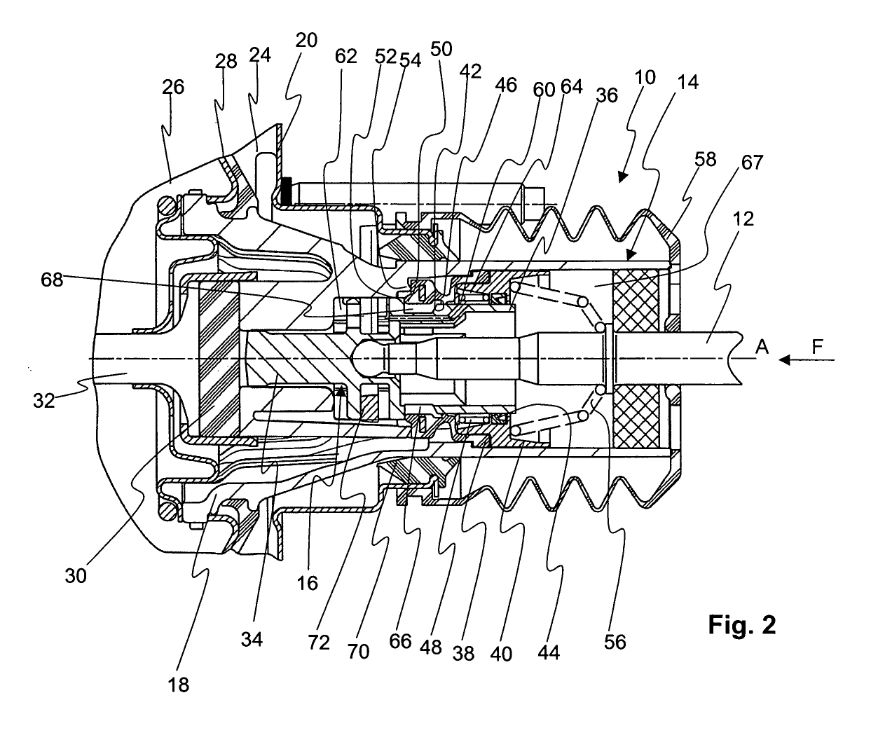

There now follows a detailed description with reference to FIG. 2 of the construction of the control valve 14 of the first embodiment according to the invention.

It is evident from FIG. 2 that the transmission piston arrangement 16 is guided displaceably in the control valve housing 18. The transmission piston arrangement 16 on its in FIG. 2 left end has a piston portion 34, which is guided displaceably in a through-opening in the control valve housing 18. This piston portion 34 in a known manner upon actuation engages into the rubber-elastic reaction element 30 and by means of the quasi-fluid behaviour thereof transmits an actuating force F, which is applied to the force input element 12, to the force output element 32.

The transmission piston arrangement 16 further has a guide portion 36, which is integrally connected to the piston portion 34. The guide portion 36 is guided in a sealingly displaceable manner in a valve element 38 as well as in a retaining element 40 that fixes the valve element 38 in the control valve housing 18. For this purpose, on the valve element 38 in a flexible bellows-like region a sealing lip 42 is provided, which slides sealingly along a cylindrical outer surface of the guide portion 36. There is further provided in the retaining element 40 a further sealing element 44, which likewise interacts sealingly with the cylindrical outer surface of the guide portion 36. It is evident that the flexible bellows-like portion 46 of the valve element 38 is preloaded in FIG. 2 to the left by means of a spring element 48. The valve element 38 on its end has an annular sealing lip 50, which forms a first (inner) sealing seat and in the initial position shown in FIG. 2 is in sealing abutment with a corresponding contact face 52 on the transmission piston arrangement 16. The valve element 38 further has, radially outside of the sealing lip 50, a radial surface portion that in the position shown in FIG. 2 has been brought into sealing abutment with an annular projection 54. The annular projection 54 forms an outer sealing seat. The inner sealing seat 50, given sealing abutment with the transmission piston arrangement 16, separates the working chamber 24 from the ambient atmosphere. The outer sealing seat 54, given sealing abutment with the valve element 38, separates the working chamber 24 from the vacuum chamber 26.

It is further evident that by means of a spring arrangement 56 the retaining element 40 is held in the position shown in FIG. 2 and presses the radially outer portion of the valve element 38 against a corresponding shoulder in the control valve housing 14. The spring arrangement 56 acts simultaneously as a resetting spring for the force input element 12. The force input element 12 is accommodated in protective bellows 58, which are connected to the brake booster housing 20 and shield the control valve 14 from external influences.

In the embodiment shown in FIGS. 1 and 2, a pressure compensation channel 60 extending in axial direction is provided in the guide portion 36 and creates a connection between a pneumatic receiving region 62, which is fluidically connected to the working chamber 24, and a region 64, which is partially delimited by the valve element 38 and in which the spring 48 is disposed. A radial pressure compensation channel 66 is further provided, which provides a pressure compensation between a central pneumatic region 67 of the control valve 14, which is connected to the atmosphere and in which the force input element 12 is disposed, and the pneumatic annular region 68, which lies radially inside the valve element 38 and is partially delimited thereby.

Finally, in FIG. 2 a sealing element 70 may additionally be seen, which is disposed inside the brake booster housing 20 and ensures a sealing guidance of the control valve housing 18 in the brake booster housing 20. Further evident is an as such known stop bar 72, which in the position shown in FIG. 2 abuts a stop shoulder formed in the brake booster housing 20 and hence limits the movement of the transmission piston arrangement 34 in FIG. 2 to the right relative to the brake booster housing 20.

The vacuum brake booster 10 according to FIGS. 1 and 2 operates like an as such known vacuum brake booster. Upon an actuation of the non-illustrated brake pedal, the force input element 12 together with the transmission piston arrangement 16 is displaced in FIG. 2 to the left. The contact face 52 of the transmission piston arrangement 16 is therefore lifted off the inner sealing seat 50, thereby leading to a connection between the working chamber 24 and the ambient atmosphere. At the movable wall 28 an excess pressure compared to the vacuum prevailing in the vacuum chamber 26 consequently builds up and leads to a follow-up displacement of the brake booster housing 18. As a result, both the actuating force F exerted by means of the force input element 12 and a booster force resulting from the pressure differential arising at the movable wall 28 are transmitted to the force output element 32. The control valve housing 18 accordingly moves up until the sealing seat 50 is applied once more onto the face 52. The vacuum brake booster 10 is then situated in a position of equilibrium, which corresponds to a specific actuating force and from which a specific braking force results. If the force input element 12 is actuated further, i.e. the brake pedal is depressed further, then—starting from this position of equilibrium—the operations just described are executed afresh.

As soon as the force input element 12 is released, because of the resetting forces stemming from the non-illustrated master cylinder arrangement at the force output element 32 and because of the resetting action of the resetting spring 56 a backward movement of the transmission piston arrangement 16 together with the force input element 12 occurs. The flexible part of the valve element 38 is therefore driven in FIG. 2 to the right so that it lifts off the sealing seat 54. This is effected, unlike in conventional vacuum brake boosters of prior art, without a high expenditure of force at the valve element 38 because the valve element 38 is substantially pressure-neutral owing to a pressure compensation by means of the pressure compensation channels 60 and 66 in the guide portion 36. In other words, at the valve element no differential pressures counteracting the displacement thereof are applied.

As a result of opening of the sealing seat 54, the vacuum chamber 26 is connected to the working chamber 24 so that the pressure difference at the movable wall 28 is reduced and a pressure compensation to the pressure level of the vacuum chamber 26 may be effected. This leads to a backward movement of the movable wall 28 together with the control valve housing 18 until the valve seat 54 is applied once more onto the valve element 38. The vacuum brake booster 10 then returns to its initial position shown in FIG. 2.

The advantage of the present invention in terms of designing the transmission piston arrangement 16 with a guide portion 36, in which the pressure compensation channels 60 and 66 are disposed, is therefore that the valve element 38 is guided in the control valve housing 18 in a substantially pressure-neutral manner, namely independently of the respective operating state. This means that in the pneumatic region 64 there can be no development, as is the case in the prior art, of for instance a differential pressure that has to be overcome during a resetting movement by a stronger design of the resetting spring 56. Rather, by means of the pressure compensation channels 60 and 66 a pressure compensation occurs, so that a differential pressure counteracting a resetting movement cannot develop at the valve element 38. This however also means that the resetting spring 56 may be of a weaker design, with the result that the total actuating forces that are perceptible to the driver may be reduced. The unwanted occurrence of increased response forces, such as may occur in the prior art, may therefore be prevented by providing the pressure compensation channels 60 and 66. In other words, pressure-dependent disturbance variables, which depending on the actuating situation may occur in systems of prior art, may be avoided by virtue of the present invention.

The formation of the pressure compensation channels in the guide portion 36 allows the measures described above to be achieved without weakening the valve element or expensively redesigning the valve element in some other way.

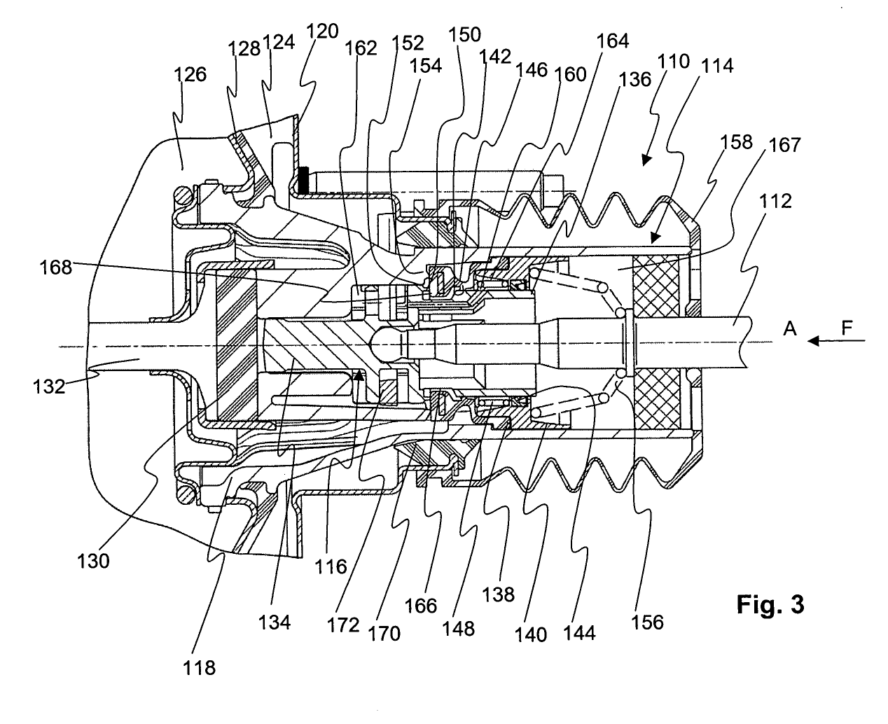

A second embodiment of the invention is represented in FIG. 3 and described below. To avoid repetition and simplify the description the same reference characters are used as in the description of FIG. 1, but prefixed by the number “1”.

The embodiment according to FIG. 3 differs from the embodiment according to FIG. 2 merely in that the valve element 138 is formed without an axial sealing seat 50 at its in FIG. 3 right radial face. Instead, the transmission piston arrangement 116 has a radially circumferential annular projection 150, which like the projection 54 on the control valve housing 18 acts as a sealing seat and sealingly abuts the planar sealing face of the valve element 138 that extends in radial direction. This allows the valve element 138 to be designed with a simplified geometry compared to the first embodiment.

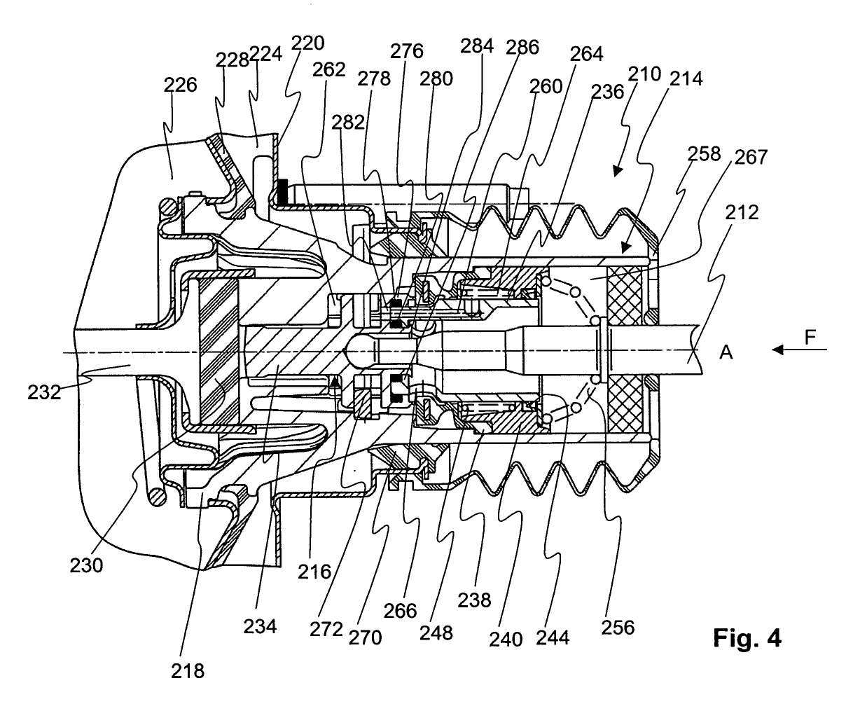

FIG. 4 shows a further embodiment of the invention. Here too, for components of an identical type or identical effect the same reference characters are used as in the embodiment according to FIGS. 1 and 2, but prefixed by the number “2”.

The embodiment according to FIG. 4 differs from the embodiment according to FIG. 3 substantially in that the transmission piston arrangement 216 is of a two-part construction. It comprises a piston portion 234, which interacts with the rubber-elastic reaction element 230, as well as the guide portion 236, which is formed separately from the piston portion 234. The guide portion 236 is however accommodated in an annular recess 276 that is formed in a corresponding receiving portion at the right end of the piston portion 34. Accommodated in this recess 276 are two sealing rings 278 and 280 that ensure a sealing abutment between the piston portion 234 and the guide portion 236. In the guide portion 236 the pressure compensation channel 260 is formed, which, apart from a radial connecting bore that opens out into the space 264, extends in axial direction. In order to create a connection to the receiving space 262, an axial bore 282 is provided in the piston portion 234 at the in FIG. 4 right end thereof. Finally, an in FIG. 4 axially extending neck region at the right end of the piston portion 234, onto which the guide portion 236 is mounted, is provided with an edge-formed portion 284, which is used to secure a corresponding annular portion 286 on the guide portion 236 against axial detachment from the piston portion 234.

Otherwise the vacuum brake booster 210 according to FIG. 4 operates in exactly the same way as described with reference to FIGS. 1 and 2.

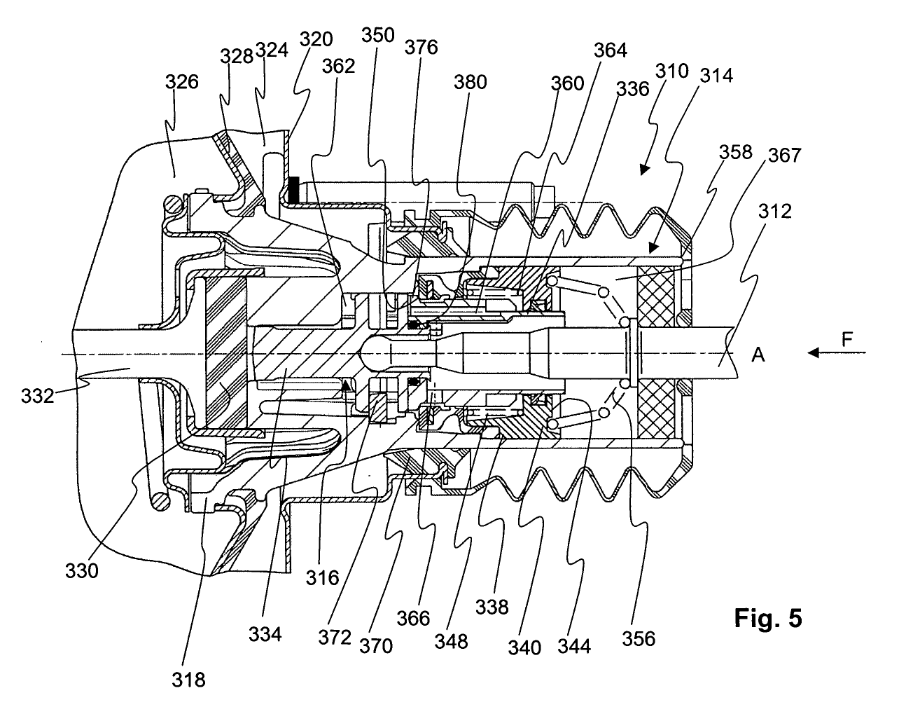

FIG. 5 shows a further embodiment of the invention, wherein here too components of an identical type or identical effect are denoted by the same reference characters as in the previous embodiments, but prefixed by the number “3”.

The embodiment according to FIG. 5 differs from the embodiment according to FIG. 4 in the configuration of the guide portion 336, which is designed in such a way that the pressure compensation channel 360 extends in purely axial direction. It is further evident that the guide portion 336 is mounted by only one ring 380 sealingly on the piston portion 334. The inner sealing seat 350 is formed by an oblique face on the guide portion 336 that interacts with a radial inside edge of the valve element 338 facing this oblique face.

On the whole, it is possible to achieve a construction that is simplified compared to FIG. 4 and, like the embodiment according to FIG. 4, offers the advantage that different materials may be used for the components: piston portion 234 and guide portion 236. It is therefore possible to manufacture the pressure-loaded piston portion 234 from a solid material, for example from a loadable plastics material or from metal, whilst the guide portion 336, which is needed only for sealing purposes, may easily be manufactured from a plastics material using an injection moulding technique.

A further advantage of the embodiment according to FIG. 5 is that the right end region of the guide portion 336 is designed with a reduced diameter. This simplifies the shape and manufacture of the pressure compensation channel 360 as it then extends only in axial direction. The pressure compensation channel 360 at the right end thereof is permanently connected by a radially extending slot fluidically to the receiving space 362.

A further effect achieved by the reduced diameter of the guide portion 336 is that the load at the transmission piston arrangement 316, upon which the pressure of the atmosphere acts, is diminished, thereby reducing the load acting upon the transmission piston arrangement 316.

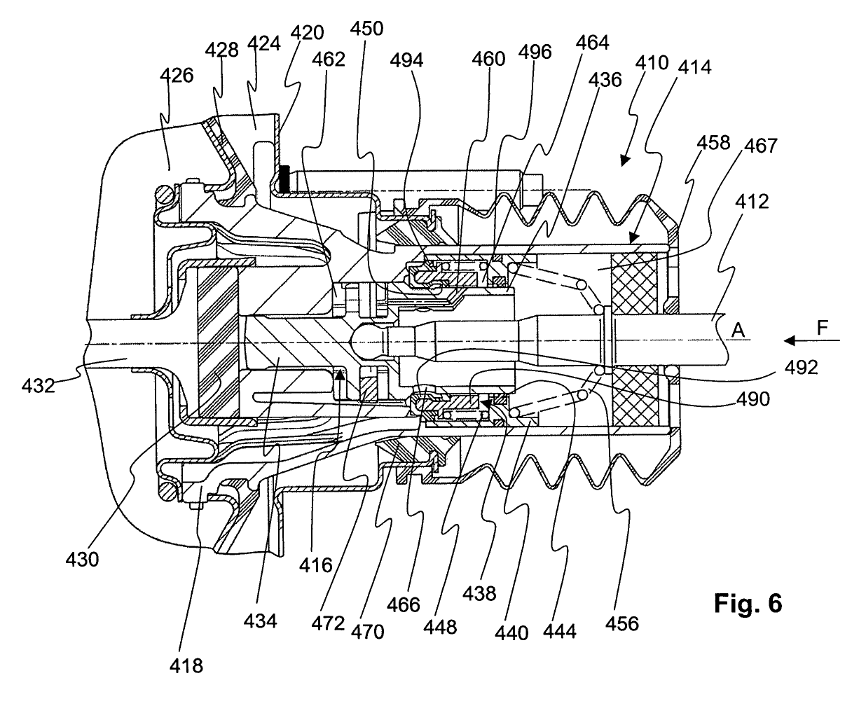

FIG. 6 shows a further embodiment of the invention, in which for components of an identical type or identical effect the same reference characters are used as previously with reference to FIGS. 1 to 5, only prefixed by the number “4”.

The embodiment according to FIG. 6 differs from the previous embodiments in that instead of a bellow-like valve element 38 a dimensionally stable valve element 438 is used, which is formed by a dimensionally stable basic body 490 that is coated with an elastomer layer 492. This basic body 490 is preloaded by means of the spring 448 relative to the retaining element 440 and guided sealingly in the retaining element 440 by means of the sealing lip 494. The elastomer coating 492 further comprises the inner sealing lip 450. Finally, it is additionally evident that the retaining element 438 is provided with a sealing ring 496 and hence is accommodated sealingly in the control valve housing 418. For receiving the resetting spring 456 the retaining element 440 has an inner shoulder region.

Otherwise the embodiment according to FIG. 6 operates in exactly the same way as described with reference to the previously described embodiments.

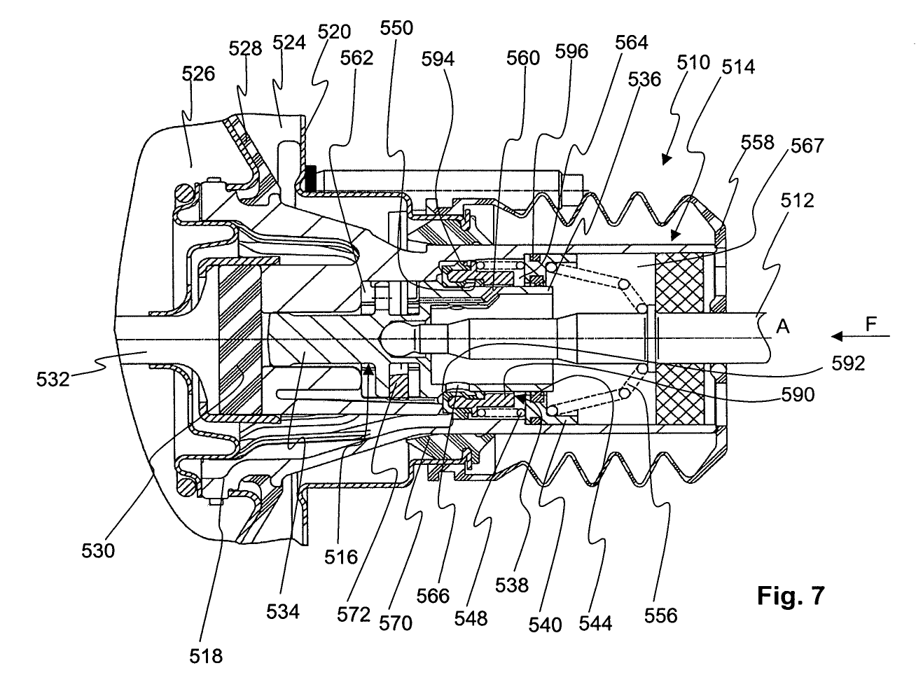

FIG. 7 shows a further embodiment of the invention, wherein here too for components of an identical type or identical effect the same reference characters are used as in the previously described embodiments, only prefixed by the number “5”.

The embodiment according to FIG. 7 differs from the embodiment according to FIG. 6 in that the retaining element 540 is designed shorter and without a radially inner guide face for the valve element 538. The valve element 538 is instead guided sealingly in the control valve housing 518. For this purpose, it is necessary to design the inner surface of the control valve housing 518 in the guide region with an appropriate surface finish that meets the sealing effect requirements.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. Vacuum brake booster for a motor vehicle brake system, having
a force input element that is connectable or connected to a brake pedal,
a chamber arrangement comprising a vacuum chamber and a working chamber that are separated from one another by a movable wall,
a control valve with a valve element for selectively connecting and separating vacuum chamber and working chamber and
a force output element for transmitting an output force to a master cylinder,
wherein the force input element is workingly connectable or connected to a transmission piston arrangement disposed in the control valve, wherein the control valve is settable in accordance with a displacement of the transmission piston arrangement along a longitudinal axis by means of the force input element, wherein the transmission piston arrangement is provided with at least one pressure compensation channel, by means of which a pressure compensation is effected at the valve element.

2. Vacuum brake booster according to claim 1, wherein the control valve has a control valve housing, wherein the transmission piston arrangement is guided in the control valve housing so as to be displaceable relative thereto and to the valve element.

3. Vacuum brake booster according to claim 2, wherein the transmission piston arrangement has an axial guide portion, which is guided sealingly in the valve element.

4. Vacuum brake booster according to claim 3, wherein a first pressure compensation channel is provided in the guide portion that extends substantially in axial direction from a pneumatic region connected to the working chamber into a first pneumatic region delimited by the valve element.

5. Vacuum brake booster according to claim 3, wherein a second pressure compensation channel is provided in the guide portion that extends substantially in radial direction from a pneumatic region connected to the atmosphere into a second pneumatic region delimited by the valve element.

6. Vacuum brake booster according to claim 3, wherein the valve element comprises first sealing means, by means of which the guide portion is guided sealingly in the valve element.

7. Vacuum brake booster according to claim 3, wherein the valve element is held in the control valve housing by means of a retaining element, wherein the guide portion is guided sealingly relative to the retaining element.

8. Vacuum brake booster according to claim 7, wherein the valve element at least in portions is displaceable in the control valve housing, wherein the displaceable portion is preloaded into an initial position by means of a resetting spring.

9. Vacuum brake booster according to claim 8, wherein the valve element comprises a dimensionally stable carrier element with an elastomer coating.

10. Vacuum brake booster according to claim 3, wherein a first sealing seat is provided on the control valve housing for interaction with the valve element and that a second sealing seat is provided on a component of the transmission piston arrangement or the valve element for interaction with the respective other component of the transmission piston arrangement or the valve element.

11. Vacuum brake booster according to claim 3, wherein the guide portion is integrally formed on the transmission piston arrangement.

12. Vacuum brake booster according to claim 3, wherein the guide portion is formed as a separate component separately from the transmission piston arrangement but sealingly connected thereto.

13. Vacuum brake booster according to claim 12, wherein the guide portion and the transmission piston arrangement are manufactured from different materials.

14. Vacuum brake booster according to claim 12, wherein the transmission piston arrangement comprises a fastening formation for sealingly receiving the guide portion.

15. Vacuum brake booster according to claim 14, wherein at least one sealing element is provided between the transmission piston arrangement and the guide portion in the region of the fastening formation.
